(19) United States
(12) Patent Application Publication
(10) Pub. No.: US 2012/0166922 A1
(43) Pub. Date: Jun. 28, 2012

(54) Content Management System for Resume and Portfolio Data for Producing Multiple Interactive Websites

(75) Inventor: Franklin Keith Rolles, Denver, NC (US)

(73) Assignee: Franklin Keith Rolles, Denver, NC (US)

(21) Appl. No.: 13/323,551

(22) Filed: Dec. 12, 2011

Related U.S. Application Data
(60) Provisional application No. 61/427,685, filed on Dec. 28, 2010.

(51) Int. Cl. G06F 17/00

(52) U.S. Cl. 715/202

(57) ABSTRACT

The Invention is a rich internet application that enables a User (content creator) to store and manage career Content (text, images, audio/video, and other media) in a database or file system over the internet in a way that the Content can be selected, retrieved, edited, and reused to create multiple, custom, and interactive resumes and websites from the Content. The invention captures and stores data at an Element level (i.e. a single resume bullet rather than an entire resume or a larger block of text) which enables versioning, selection, comparison, and maintenance of the Elements and enables Associations (stored relationships, links) between Elements (e.g. between a keyword and a resume bullet, or between a resume bullet and a Storyboard multimedia object). The method of storing, managing, and associating Elements facilitates the creation of multiple custom resumes and websites and yields interactive and concurrent views of the User's Content.

### CROSS-REFERENCES TO RELATED APPLICATION

Provisional Patent 61/427,685; Filing Date: Dec. 28, 2010

### STATEMENT REGARDING FEDERALLY SPONSORED RESEARCH OR DEVELOPMENT

Not Applicable (Not Sponsored)

### BACKGROUND OF THE INVENTION

CLASS 715, DATA PROCESSING: PRESENTATION PROCESSING OF DOCUMENT, OPERATOR INTERFACE PROCESSING, AND SCREEN SAVER DISPLAY PROCESSING

1. Field of the Invention

The invention relates to a system including software and electronic methods of organizing and managing content (text, images, video, and other data) to produce multiple custom views of content in a manner such as on a web page, as part of an interactive object on a web page, or as a text document.

2. Background of the Invention

Career counselors have given advice to customize your resume for a given opportunity. In today's world, when computer systems do most of the initial candidate screening by searching for exact keyword and phrase matches in the resume document, creating a custom resume for each position is important. By managing resume data as individual elements in a database, The Content Management System makes it easy to pick and choose elements and to rearrange them to customize output (resumes and websites). The maintenance features built into the Content Management System make it easy to manage multiple resumes and to update all or one of them with the click of a button.

With the rise of the internet as a primary means of business communication, the paper resume is beginning to be replaced by online resumes and profiles. The Content Management System allows users to create customized and highly interactive websites for each opportunity.

While the resume is still a necessary document, it is essentially a bulleted list of accomplishments and is a poor vehicle for communicating a person's experience and value. Additionally, since it is common knowledge that many people embellish their experience on the resume, resumes tend to be viewed with skepticism. Studies have shown that the most effective and most memorable way to communicate is through the use of story. By utilizing the full multi-media potential of the web, the Content Management System enables users to tell the stories behind their professional accomplishments. They can explain their role in a project, what skills and tools they used to achieve their results, and how they overcame obstacles to succeed. Telling more of the story boosts their credibility and makes them more memorable.

While there are some other online resume tools that enable users to add photos or video to the sidebar or below the resume, the Content Management System and it's unique method of associating data elements generates websites where elements can be interactive and convey deeper meaning.

For example, the keywords (skills) in the keyword table are interactive. When a word (skill) is clicked, a sub-window will open displaying a sorted list of resume bullets that demonstrate experience in that skill.

Clicking the “more” button after a bullet will bring up a multi-page, multi-media storyboard to show and tell the story behind the bullet. The profile photo can be interactive and when clicked will pull up a personal message video. Every item in the portfolio and sidebar can be clicked to open and explore the multi-media stories.

The Content Management System can display information in an interactive timeline, where clicking on a section of the timeline will bring up the work experience (bullets) and storyboard elements from that period of time.

The Content Management System addresses multiple long-standing problems associated with career management, job searching, and personal branding while providing a single repository, hosted in the cloud and accessible from anywhere, to store and manage career information. This information (data) can be arranged and assembled by the user to create multiple custom resumes and websites.

### Advantages Over Prior Art:

The following key advantages of the Content Management System compared to prior art include:
Captures the User's last edit (add, edit, or delete) on any resume and displays the difference in all other resumes, eliminating the need for a side-by-side comparison of entire documents to determine where the differences are.
Provides easy to use maintenance buttons to update custom resumes or websites when new information is added, deleted, or edited in any resume or website. This eliminates the need to make the same correction or modification in multiple documents.
Allows the User to create and save multiple versions of Elements (e.g. a bullet on a resume, paragraph, or table) within a resume. The versions may emphasize different skills used during an accomplishment. The User can then select which version of the Element he wants to include in a particular resume or website.
Allows the User to create multi-paged, multi-media Storyboard Elements which can be displayed in-line with resume bullets with a link (Association), on the resume sidebar, and on other pages of the User's websites.
Allows the User to make Associations among Elements of a resume/portfolio which can be used to generate multiple views of the information in resulting output websites (e.g. display a chronological resume and a functional resume concurrently or display an interactive timeline view). This adds drill-down interactivity and depth to the resulting output.
Allows the User to quickly customize multiple resumes and websites, each with its own private URL), that can be tailored to different networking and job opportunities by drawing from the User's Content in the Content Management System.

### BRIEF SUMMARY OF THE INVENTION

The Invention is a rich internet application that enables a User (content creator) to store and manage his career portfolio of Content (text, images, audio/video, and other media) in a database or file system over the internet in a way that the Content can be selected, retrieved, edited, and reused to create multiple, custom, and interactive resumes and websites from the Content. The invention captures and stores data at an Element level (i.e. a single resume bullet rather than the entire resume or a larger block of text) which enables versioning, selection, comparison, and maintenance of the Elements and enables Associations (stored relationships, links) between Elements (e.g. between a keyword and a resume bullet, or between a resume bullet and a Storyboard multimedia object). The combination of storing, managing, and associating Elements facilitates the creation of multiple resumes and websites and yields interactive and multiple concurrent views of the User's Content.

Other online resume services may allow a User to have multiple resumes; but, each resume is a distinct and static container of information. In order to create a new resume with those services, a User must either build a new resume from scratch or copy information from an existing resume and edit it to get the desired result. This approach is cumbersome and difficult to maintain over time because differences between versions are not readily visible and each resume must be edited in isolation. For example, if a User wants to correct a typographical error in multiple copies of a resume, he would need to make the change in all copies. If he wants to know how one copy differs from another, he would need to review both documents in their entirety and compare and contrast.

The Content Management System solves the problems associated with managing multiple, custom resumes by highlighting differences between resumes, by allowing multiple versions of Elements (e.g. a bullet, paragraph, or table on a resume), and by providing maintenance functionality to update one or all resumes.

The Content Management System captures the User's last edits on ALL resumes so he can see changes on ANY resume. For example, a User creates Resume #2 by duplicating Resume #1 then adds a new Element (bullet) to Resume #2. The system tracks the last edit, which in this case is the addition; so, when the User returns to Resume #1 he sees the new Element, marked as new, which was added in Resume #2. Note that the Element only appears in the editing side of the application; the User would need to accept the new Element before it would appear on the output. Similarly, if the User edited a bullet on Resume #2 and then returned to Resume #1, the system would highlight that the bullet had been edited since the time Resume #1 had been created. The User can then use the maintenance functions to see the current (unchanged) content side-by-side with the last-edit content and decide to update Resume #1 or utilize other maintenance choices. The system also works for delete actions. The Content Management System preserves previously created resumes but shows the User where all adds, edits, and deletes have been made, making it easy to update and maintain multiple resumes concurrently. The Content Management System also has functionality that allows correcting typos across all resumes with a single action (Correct Typos).

In addition to the maintenance features described above, the Content Management System has unique functionality to create multiple versions of resume Elements. For example, the User can create multiple versions of a single bullet (accomplishment) thereby highlighting different skills in the various versions. The User can then select the most appropriate version to include on his various resumes. All of this is happening while last edit is capturing differences in the background. This approach maximizes the User's ability to customize his work experience in order to develop highly customized resumes and websites to match networking or job opportunities.

The Content Management System collects data at an Element (object) level which allows linking Elements to one another. Linking or Associations between Elements are stored in the database and allow the Content Management System to deliver interactive views of data on the resulting output websites. An example of an Element is a single bullet on a resume. Other online resume services collect data either as the entire text version of the resume or in text blocks of several bullets. The Content Management System's method of capturing data at the Element level allows associations between Elements in the system and yields more interactive websites as a result. For example, a keyword such as “Financial Analysis” is an Element which can be Associated to several bullets (Elements) on the resume. Through the Associations, the Content Management System can display the User's resume in a traditional chronological format AND when a viewer presses the “Financial Analysis” interactive button, can display the resume in a functional view. The method allows information to be presented in multiple, concurrent, and dynamic ways.

In summary, the Content Management System's unique system and methods including content management at the Element level, Association functionality, Element versioning, and maintenance allow the User to create and manage multiple, custom, and interactive resumes and websites with ease.

### BRIEF DESCRIPTION OF THE DRAWINGS

FIG. 1: A diagram for the Content Management System including data input at the Element level and management (create, modify, and update) for multiple custom resumes and websites.

FIG. 2: Diagram showing how existing online resume/portfolio services store data for multiple online resumes/portfolios

FIG. 3: Diagram showing how the Content Management System would store and manage data including a last-edit repository

FIG. 4: Diagram showing how capturing and storing data at the Element level can facilitate associations between Elements

FIG. 5: A diagram representing a traditional chronological resume output display with new interactive buttons for keywords and storyboards.

FIG. 6: A diagram representing alternative displays of the data based on keyword association (e.g. a functional view of the resume, concurrently with the traditional chronological view, FIG. 5).

### DETAILED DESCRIPTION OF THE INVENTION

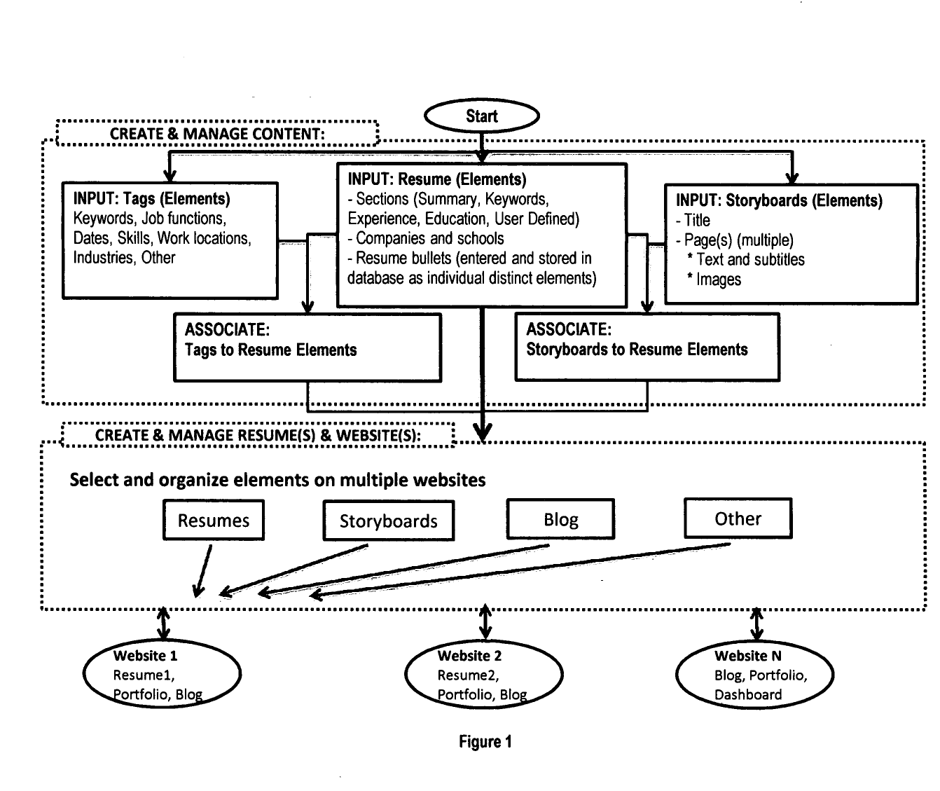

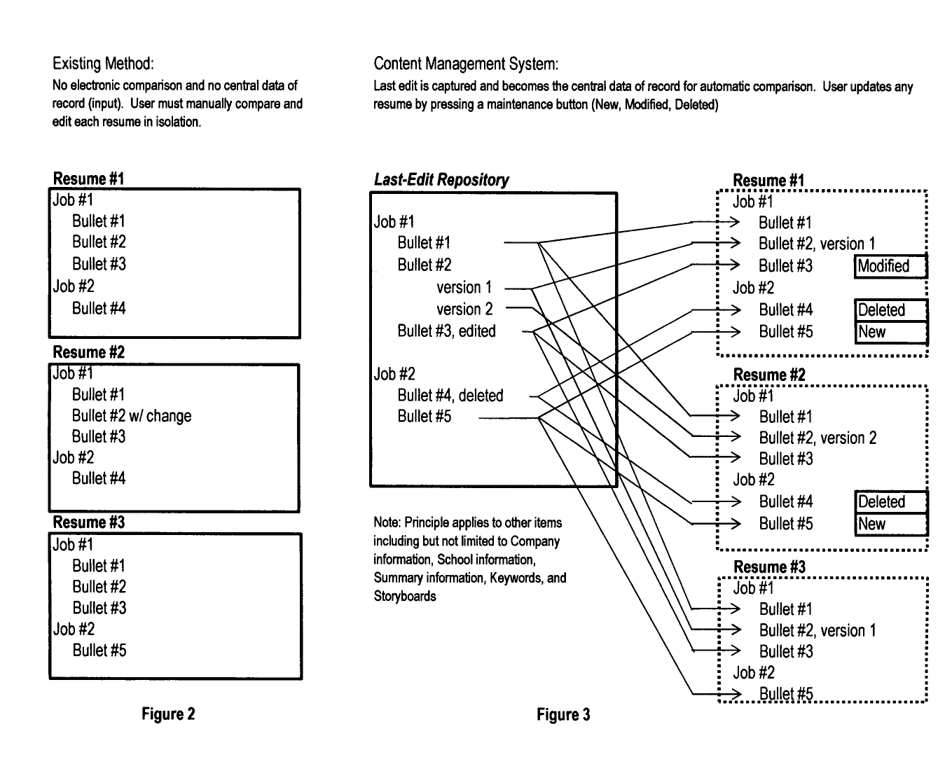

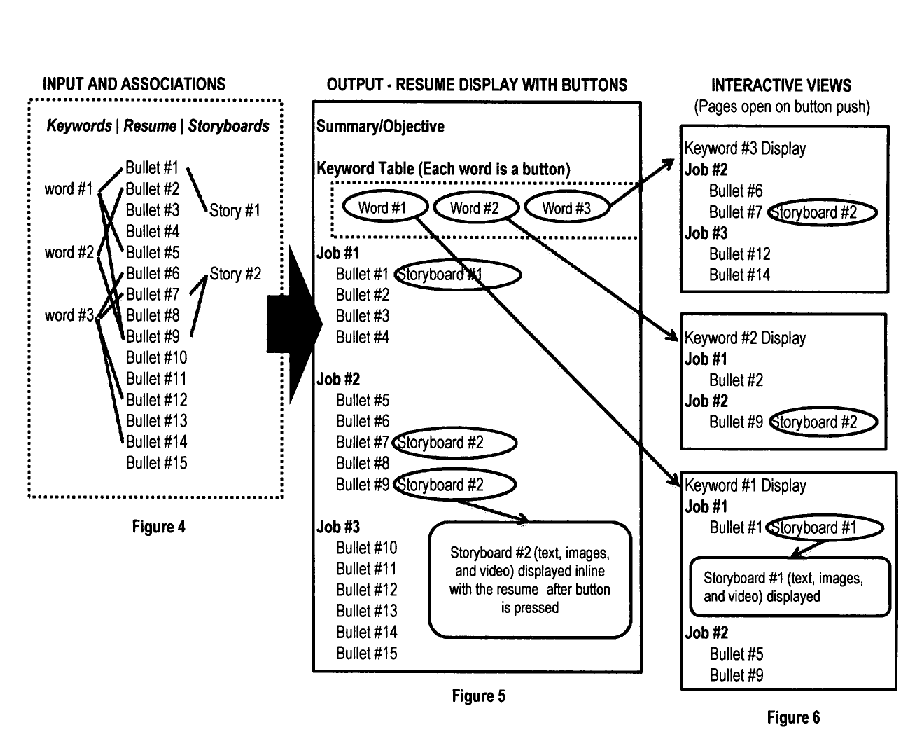

The Content Management System provides four main activities (FIG. 1): a) inputting data at the Element level, b) defining associations between Elements, c) creating multiple resumes and websites by selecting, filtering, sorting and arranging data Elements, and d) maintaining resumes and websites by viewing differences between data in the custom resume and the last-edit repository, then taking action (User options) as appropriate.

Input of data will occur through the use of web forms and data will be stored in the database at the Element level (for example: summary text, keywords, schools, employers, resume bullets, storyboards, dates, and other metadata). Collecting and storing each piece of data as a separate object allows Association (links) between objects to be defined by the User.

Associations between Elements in the database will be made through on screen interaction by the User such as click-and-drag or pick lists. Once made, the Associations are stored in relational tables in the database and can be used to create multiple views of the data on the output resume(s) and website(s).

The User can create multiple resumes and websites using data stored in the database by selecting or deselecting data Elements. The User can also arrange the Elements on the resumes and websites by clicking- and dragging or by button actions. The tool allows the User to select and arrange the items from the database in multiple ways and across multiple web pages. When the User saves the resume or website the information is preserved at that moment such that it can be later compared to the last-edit made on any resume or website.

The User is provided with options to update the resume or website on an Element-by-Element basis, to perform a mass update, or to ignore the differences and preserve the original data. These options are executed by pressing maintenance buttons, not by editing data in each resume or website. The User only has to make changes in one location (i.e. resume) and the changes can either be instantaneously applied to all other locations or are highlighted such that the User can make the decision what to do about the difference in the particular resume or website. He does not need to redo the edit in multiple locations. Updates, if not applied to all locations, happen with the press of a maintenance button. These functions make it easy to identify differences and to maintain multiple resumes and websites concurrently.

Because of the way data is collected and stored at the Element level along with the capability to define associations between Elements (FIGS. 3 & 4), the web output display for the custom resume(s) and website(s) can be interactive (FIGS. 5 & 6). For example, the following process may ensue: 1) User enters data Elements including keywords, resume bullets, and storyboards; 2) the User makes associations between keywords and bullets and bullets and storyboards; 3) the User creates a website which has a page for the resume; 4) a traditional resume is displayed (FIG. 5) that also has interactive buttons; 5) when a storyboard (more) button is pressed a storyboard (text, images, and video) will appear in-line with the resume; and 6) when a keyword button is pressed a keyword (functional resume) view of the resume can be displayed. The associations enable various views of the data concurrently with the traditional, flat, resume view. Other views of data could include but are not limited to worked-in location map, an interactive timeline, job functions view, skills view, etc. The ability to create multiple views, drill down capability, and interactivity is unique and enabled by the Content Management System.

In addition to collecting data at the Element level, such as a resume bullet, the Content Management System has functionality to create and save multiple versions of Elements within a resume. This allows the User to create versions that emphasize different skills used on the particular bullet (work experience), different spins on the same accomplishment. This approach allows the various spins to be readily available on multiple resumes without the possibility of duplicating the accomplishment. The User specifies which version of the bullet they want on the particular resume. The versioning approach adds flexibility and ease to creating custom resumes geared toward a particular networking or job opportunity.

The Content Management System and the method of storing, editing, selecting, arranging, and linking Elements makes it easy to create and manage multiple custom resumes and websites that can be targeted to specific networking and job opportunities. The method of making associations between Elements in the Content Management System allows the display of the Content to be in-line and interactive for viewers, making it more dynamic compared to flat on-line profiles or resumes.

1. A Content Management System (forms, processes, functions, database, and file system, and display) that captures and stores User supplied Content at an Element level (e.g., but not limited to, individual bullets on a resume, keywords, or storyboard objects) and allows the user to select, edit, link, and organize the Elements to produce multiple, custom, and interactive resumes and websites.

2. A method of comparing data in multiple custom resumes or websites to the last edit data in the Content Management System in order to highlight differences (new, deleted, changed) between several resumes or websites and to provide functions to edit and update (maintain original; update Element-by-Element; and update all) the data in each resume or website based on the comparisons.

3. A method of creating and storing Associations (links) between Elements in the Content Management System via forms and functions such as buttons, click and drag, pick lists or other means to produce multiple interactive and concurrent views of Content (e.g., but not limited to, in-line display of additional multimedia data, concurrent chronological and functional views of resume data, or web pages with additional/different views).
